(19) United States
(12) Patent Application Publication
(10) Pub. No.: US 2017/0216791 A1
(43) Pub. Date: Aug. 3, 2017

(54) IN-LINE DYNAMIC MIXING APPARATUS FOR FLOCCULATING AND DEWATERING OIL SANDS FINE TAILINGS

(71) Applicant: Dow Global Technologies LLC, Midland, MI (US)

(72) Inventors: Paul A. Gillis, Lake Jackson, TX (US); Jason S. Moore, Walnut Creek, CA (US); Billy G. Smith, Brazoria, TX (US); Michael D. Cloeter, Lake Jackson, TX (US); Michael K. Poindexter, Sugar Land, TX (US); Irfan Khan, Houston, TX (US)

(73) Assignee: Dow Global Technologies LLC, Midland, MI (US)

(21) Appl. No.: 15/328,552

(22) PCT Filed: Jul. 31, 2015
(86) PCT No.: PCT/US15/43043

§ 371 Date: Jan. 24, 2017

Related U.S. Application Data
(60) Provisional application No. 62/031,358, filed on Jul. 31, 2014.
(60) Provisional application No. 62/152,277, filed on Apr. 24, 2015.

(51) Int. Cl. B01F 7/00; C02F 1/56; B01F 7/18; C02F 11/14

(52) U.S. Cl. CPC B01F 7/00908; C02F 11/14; C02F 1/56; B01F 7/183; B01F 7/00258; B01F 7/003; B01F 7/00633; C02F 2103/10

(57) ABSTRACT

The present invention relates to an in-line mixing apparatus and use therein for adding a polymer solution and dewatering an aqueous mineral suspension. Said method comprises statically mixing the aqueous mineral suspension with a poly(ethylene oxide) (co) polymer to form a dough-like material. The viscous mixture material is then dynamically mixed in an in-line reactor 40 to reduce the mixture viscosity and to form microflocs and release water. Said method is particularly useful for the treatment of suspensions of particulate material, especially waste mineral slurries, especially for the treatment of tailings and other waste material resulting from mineral processing, in particular, the processing of oil sands tailings.

### FIELD OF THE INVENTION

The present invention relates to an in-line dynamic mixing apparatus and process for treating aqueous mineral suspensions, especially waste mineral slurries, using a polymeric flocculant composition, preferably comprising a poly(ethylene oxide) homo- or copolymer. The process of the present invention is particularly suitable for the treatment of tailings and other waste material resulting from mineral processing, in particular, processing of oil sands tailings.

### BACKGROUND OF THE INVENTION

Fluid tailings streams derived from mining operations, such as oil sands mining operations, are typically composed of water and solid particles. In order to recover the water and consolidate the solids, solid/liquid separation techniques must be applied. In oil sands processing a typical fresh tailings stream comprises water, sand, silt, clay and residual bitumen. Oil sands tailings typically comprise a substantial amount of fine particles (which are defined as solids that are less than 44 microns).

The bitumen extraction process utilizes hot water and chemical additives such as sodium hydroxide or sodium citrate to remove the bitumen from the ore body. The side effect of these chemical additives is that they can change the inherent water chemistry. The inorganic solids as well as the residual bitumen in the aqueous phase acquire a negative charge. Due to strong electrostatic repulsion, the fine particles form a stabilized suspension that does not readily settle by gravity, even after a considerable amount of time. In fact, if the suspension is left alone for 3-5 years, a gel-like layer known as mature fine tailings (MFT) will be formed and this type of tailings is very difficult to consolidate even with current technologies.

Recent methods for dewatering MFT are disclosed in WO 2011/032258 and WO 2001/032253, which describe in-line addition of a flocculant solution, such as a polyacrylamide (PAM), into the flow of oil sands tailings, through a conduit such as a pipeline. Once the flocculant is dispersed into the oil sands tailings, the flocculant and tailings continue to mix as they travel through the pipeline and the dispersed clays, silt, and sand bind together (flocculate) to form larger structures (flocs) that can be separated from the water when ultimately deposited in a deposition area. However, the degree of mixing and shearing is dependent upon the flow rate of the materials through the pipeline as well as the length of the pipeline. Thus, any changes in the fluid properties or flow rate of the oil sands fine tailings may have an effect on both mixing and shearing and ultimately flocculation. Thus, if one has a length of open pipe, it would be difficult to control flocculation because of the difficulty in independently controlling both the shear rate and residence time simply by changing the flow rate.

CA Patent Application No. 2,512,324 suggests addition of water-soluble polymers to oil sands fine tailings during the transfer of the tailings as a fluid to a deposition area, for example, while the tailings are being transferred through a pipeline or conduit to a deposition site. However, once again, proper mixing of polymer flocculant with tailings is difficult to control due to changes in the flow rate and fluid properties of the tailings material through the pipeline.

US Publication No. 2013/0075340 discloses a process for flocculating and dewatering oil sands tailings comprising adding oil sands tailings as an aqueous slurry to a stirred tank reactor; adding an effective amount of a polymeric flocculant, such as charged or uncharged polyacrylamides, to the stirred tank reactor containing the oil sands tailings, dynamically mixing the flocculant and oil sands tailings for a period of time sufficient to form a gel-like structure; subjecting the gel-like structure to shear conditions in the stirred tank reactor for a period of time sufficient to break down the gel-like structure to form flocs and release water; and removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

While polyacrylamides are generally useful for fast consolidation of tailings solids, they are highly dose sensitive towards the flocculation of fine particles and it is challenging to find conditions under which a large proportion of the fine particles are flocculated. As a result, the water recovered from a PAM consolidation process is often of poor quality and may not be good enough for recycling because of high fines content in the water. Additionally, tailings treated with PAM are shear sensitive so transportation of treated thickened tailings to a dedicated disposal area (DDA) and general materials handling can become a further challenge.

Alternatively, polyethylene oxide (PEO) is known as a flocculant for mine tailings capable of producing a lower turbidity supernatant as compared to PAM, for example see U.S. Pat. Nos. 4,931,190; 5,104,551; 6,383,282; WO 2011070218; Sharma, S. K., Scheiner, B. J., and Smelley, A. G., (1992). Dewatering of Alaska Pacer Effluent Using PEO. United States Department of the Interior, Bureau of Mines, Report of Investigation 9442; and Sworska, A., Laskowski, J. S., and Cymerman, G. (2000). Flocculation of the Syncrude Fine Tailings Part II. Effect of Hydrodynamic Conditions. Int. J. Miner. Process, 60, pp. 153-161. However, PEO polymers have not found widespread commercial use in oil sand tailings treatment because of mixing and processing challenges resulting from its high viscosities with clay-based slurries.

In spite of the numerous processes and polymeric flocculating agents used therein, there is still a need for a flocculating process to further improve the settling and consolidation of suspensions of materials as well as further improve upon the dewatering of suspensions of waste solids that have been transferred as a fluid or slurry to a settling area for disposal. In particular, it would be desirable to provide a more effective treatment of waste suspensions, such as oil sands tailings, transferred to disposal areas ensuring improved concentration of solids and improved clarity of released water with improved shear stability and wider dose tolerance.

### BRIEF SUMMARY OF THE INVENTION

The present invention is a process for flocculating and dewatering oil sands fine tailings, comprising the steps: i) providing an in-line flow of an aqueous suspension of oil sands fine tailings through a pipe, said pipe having an internal diameter, ii) introducing a flocculant composition comprising a poly(ethylene oxide) (co)polymer, preferably a poly(ethylene oxide) homopolymer, a poly(ethylene oxide) copolymer, or mixtures thereof, into the aqueous suspension of oil sands fine tailings, iii) mixing the flocculant composition and the aqueous suspension of oil sands fine tailings without dynamic mixers, e.g., no moving parts such as a rotating impeller to input additional energy t for a period of time sufficient to form a dough-like material, iv) introducing the dough-like material into an in-line reactor through the pipe wherein the internal diameter of the in-line reactor is equal to or less than five times the internal diameter of the pipe, v) subjecting the dough-like material to dynamic mixing within the in-line reactor for a period of time sufficient to break down the dough-like material to form microflocs and release water, wherein the resulting flocculated oil sands tailings has a viscosity equal to or less than 1,000 cP and a yield stress of equal to or less than 300 Pa, and said microflocs have an average size from 1 to 500 microns, vi) flowing the flocculated oil sands fine tailings from the in-line reactor through a pipe or one or more static mixer or a combination of piping and one or more static mixer, and vii) further treating or depositing the flocculated oil sands fine tailings.

One embodiment of the process of the present invention described herein above further comprises the step: viii) adding the flocculated oil sands fine tailings to at least one centrifuge to dewater the flocculated oil sands fine tailings and form a high solids cake and a low solids centrate.

Another embodiment of the process of the present invention described herein above further comprises the step: viii) adding the flocculated oil sands fine tailings to a thickener to dewater the flocculated oil sands fine tailings and produce thickened oil sands fine tailings and clarified water.

Another embodiment of the process of the present invention described herein above further comprises the step: viii) adding the flocculated oil sands fine tailings to at least one deposition cell such as an accelerated dewatering cell for dewatering.

Another embodiment of the process of the present invention described herein above further comprises the step: viii) spreading the flocculated oil sands fine tailings as a thin layer onto a sloped deposition site.

In one embodiment of the process of the present invention disclosed herein above, the polymeric flocculant is a poly(ethylene oxide) homopolymer or poly(ethylene oxide) copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

In one embodiment of the process of the present invention disclosed herein above, the poly(ethylene oxide) (co)polymer has a molecular weight of equal to or greater than 1,000,000 Da.

### BRIEF DESCRIPTION OF THE DRAWINGS

FIG. 1 is a schematic of embodiments A to D of the process of the present invention.

FIG. 2 is a schematic plain view of a dynamic mixer apparatus of one embodiment of the process of the present invention for dynamically mixing a flocculant with an aqueous suspension of oil sands fine tailings.

FIG. 3 shows two different rotor designs for the dynamic mixer apparatus of the present invention.

FIG. 4 shows two different stator designs for the dynamic mixer apparatus of the present invention.

FIG. 5 is a copy of a photograph of microflocs generated by the process of the present invention.

FIG. 6 is a graph showing the settling curve for Example 2 wherein mature fine tailings are treated by the process of the present invention.

FIG. 7 provides plots of the velocity vector and shear rate profiles obtained from CFD simulations of a rotor/stator assembly.

FIG. 8 provides plots of the velocity vector and shear rate profiles obtained from CFD simulations of a rotor/wall baffle assembly.

FIG. 9 is a schematic plain view of a dynamic mixer apparatus of a second embodiment of the process of the present invention for dynamically mixing a flocculant with an aqueous suspension of oil sands fine tailing.

### DETAILED DESCRIPTION OF THE INVENTION

According to the present invention, we provide a process for dewatering an aqueous mineral suspension comprising introducing into the suspension a flocculating composition comprising a poly(ethylene oxide) homopolymer, a poly(ethylene oxide) copolymer, or mixtures thereof, herein after collectively referred to as “poly(ethylene oxide) (co)polymer”. Typically, the material to be flocculated may be derived from or contain filter cake, tailings, thickener underflows, or unthickened plant waste streams, for instance other mineral tailings, slurries, or slimes, including phosphate, diamond, gold slimes, mineral sands, tails from zinc, lead, copper, silver, uranium, nickel, iron ore processing, coal, oil sands or red mud. The material may be solids settled from the final thickener or wash stage of a mineral processing operation. Thus the material desirably results from a mineral processing operation. Preferably the material comprises tailings. Preferably the mineral material would be selected from red mud and tailings containing clay, such as oil sands tailings, etc.

The oil sands tailings or other mineral suspensions may have a solids content in the range 5 percent to 80 percent by weight. The slurries or suspensions often have a solids content in the range of 10 percent to 70 percent by weight, for instance 25 percent to 40 percent by weight. The sizes of particles in a typical sample of the fine tailings are substantially all less than 45 microns, for instance about 95 percent by weight of material is particles less than 20 microns and about 75 percent is less than 10 microns. The coarse tailings are substantially greater than 45 microns, for instance about 85 percent is greater than 100 microns but generally less than 10,000 microns. The fine tailings and coarse tailings may be present or combined together in any convenient ratio provided that the material remains pumpable.

The dispersed particulate solids may have a unimodal, bimodal, or multimodal distribution of particle sizes. The distribution will generally have a fine fraction and a coarse fraction, in which the fine fraction peak is substantially less than 44 microns and the coarse (or non-fine) fraction peak is substantially greater than 44 microns.

The flocculant composition of the process of the present invention comprises a polymeric flocculant, preferably poly(ethylene oxide) homopolymer, a poly(ethylene oxide) copolymer, or mixtures thereof. Poly(ethylene)oxide (co)polymers and methods to make said polymers are known, for example see WO 2013116027. In one embodiment of the present invention, a zinc catalyst, such as disclosed in U.S. Pat. No. 4,667,013, can be employed to make the poly(ethylene oxide) (co)polymers of the present invention. In a preferred embodiment the catalyst used to make the poly(ethylene oxide) (co)polymers of the present invention is a calcium catalyst such as those disclosed in U.S. Pat. Nos. 2,969,402; 3,037,943; 3,627,702; 4,193,892; and 4,267,309, all of which are incorporated by reference herein in their entirety.

A preferred zinc catalyst is a zinc alkoxide catalyst as disclosed in U.S. Pat. No. 6,979,722, which is incorporated by reference herein in its entirety.

A preferred alkaline earth metal catalyst is referred to as a “modified alkaline earth hexammine” or a “modified alkaline earth hexammoniate” the technical terms “ammine” and “ammoniate” being synonymous. A modified alkaline earth hexammine useful for producing the poly(ethylene oxide) (co)polymer of the present invention is prepared by admixing at least one alkaline earth metal, preferably calcium metal, strontium metal, or barium metal, zinc metal, or mixtures thereof, most preferably calcium metal; liquid ammonia; an alkylene oxide; which is optionally substituted by aromatic radicals, and an organic nitrile having at least one acidic hydrogen atom to prepare a slurry of modified alkaline earth hexammine in liquid ammonia; continuously transferring the slurry of modified alkaline earth hexammine in liquid ammonia into a stripper vessel and continuously evaporating ammonia, thereby accumulating the modified catalyst in the stripper vessel; and upon complete transfer of the slurry of modified alkaline earth hexammine into the stripper vessel, aging the modified catalyst to obtain the final polymerization catalyst. In a preferred embodiment of the alkaline earth metal catalyst of the present invention described herein above, the alkylene oxide is propylene oxide and the organic nitrile is acetonitrile.

A catalytically active amount of alkaline earth metal catalyst is used in the process to make the poly(ethylene oxide) (co)polymer of the present invention, preferably the catalyst is used in an amount from 0.0004 to 0.0040 g of alkaline earth metal per gram of epoxide monomers (combined weight of all monomers, e.g., ethylene oxide and silane- or siloxane-functionalized glycidyl ether monomers), preferably 0.0007 to 0.0021 g of alkaline earth metal per gram of epoxide monomers, more preferably 0.0010 to 0.0017 g of alkaline earth metal per gram of epoxide monomers, and most preferably 0.0012 to 0.0015 g of alkaline earth metal per gram of epoxide monomer.

The catalysts may be used in dry or slurry form in a conventional process for polymerizing an epoxide, typically in a suspension polymerization process. The catalyst can be used in a concentration in the range of 0.02 to 10 percent by weight, such as 0.1 to 3 percent by weight, based on the weight of the epoxide monomers feed.

The polymerization reaction can be conducted over a wide temperature range. Polymerization temperatures can be in the range from −30° C. to 150° C. and depends on various factors, such as the nature of the epoxide monomer(s) employed, the particular catalyst employed, and the concentration of the catalyst. A typical temperature range is from 0° C. to 150° C.

The pressure conditions are not specifically restricted and the pressure is set by the boiling points of the diluent and comonomers used in the polymerization process.

In general, the reaction time will vary depending on the operative temperature, the nature of the comonomer(s) employed, the particular catalyst and the concentration employed, the use of an inert diluent, and other factors. As defined herein copolymer may comprise more than one monomer, for instance there can be two comonomers, three comonomers, four comonomers, five comonomers, and so on. Suitable comonomers include, but are not limited to, epichlorohydrin, propylene oxide, butylene oxide, styrene oxide, an epoxy functionalized hydrophobic monomer, a glycidyl ether or glycidyl propyl functionalized hydrophobic monomer, a silane-functionalized glycidyl ether or glycidyl propyl monomer, a siloxane-functionalized glycidyl ether or glycidyl propyl monomer, an amine or quaternary amine functionalized glycidyl ether or glycidyl propyl monomer, and a glycidyl ether or glycidyl propyl functionalized fluorinated hydrocarbon containing monomer. Specific comonomers include but are not limited to, 2-ethylhexylglycidyl ether, benzyl glycidyl ether, nonylphenyl glycidyl ether, 1,2-epoxydecane, 1,2-epoxyoctane, 1,2-epoxytetradecane, glycidyl 2,2,3,3,4,4,5,5-octafluoropentyl ether, glycidyl 2,2,3,3-tetrafluoropropyl ether, octylglycidyl ether, decylglycidyl ether, 4-chlorophenyl glycidyl ether, 1-(2,3-epoxypropyl)-2-nitroimidazole, 3-glycidylpropyl triethoxysilane, 3-glycidoxypropyldimethylethoxysilane, diethoxy(3-glycidyloxypropyl)methylsilane, poly(dimethylsiloxane) monoglycidylether terminated, and (3-glycidylpropyl)trimethoxysilane. Polymerization times can be run from minutes to days depending on the conditions used. Preferred times are 1 h to 10 h.

The ethylene oxide may be present in an amount equal to or greater than 2 weight percent, preferably equal to or greater than 5 weight percent, and more preferably in an amount equal to or greater than 10 weight percent based on the total weight of said copolymer. The ethylene oxide may be present in an amount equal to or less than 98 weight percent, preferably equal to or less than 95 weight percent, and more preferably in an amount equal to or less than 90 weight percent based on the total weight of said copolymer.

The one or more comonomer may be present in an amount equal to or greater than 2 weight percent, preferably equal to or greater than 5 weight percent, and more preferably in an amount equal to or greater than 10 weight percent based on the total weight of said copolymer. The one or more comonomer may be present in an amount equal to or less than 98 weight percent, preferably equal to or less than 95 weight percent, and more preferably in an amount equal to or less than 90 weight percent based on the total weight of said copolymer. If two or more comonomers are used, the combined weight percent of the two or more comonomers is from 2 to 98 weight percent based on the total weight of said poly(ethylene oxide) copolymer.

The copolymerization reaction preferably takes place in the liquid phase. Typically, the polymerization reaction is conducted under an inert atmosphere, e.g., nitrogen. It is also highly desirable to affect the polymerization process under substantially anhydrous conditions. Impurities such as water, aldehyde, carbon dioxide, and oxygen which may be present in the epoxide feed and/or reaction equipment should be avoided. The poly(ethylene oxide) (co)polymers of this invention can be prepared via the bulk polymerization, suspension polymerization, or the solution polymerization route, suspension polymerization being preferred.

The copolymerization reaction can be carried out in the presence of an inert organic diluent such as, for example, aromatic hydrocarbons, benzene, toluene, xylene, ethylbenzene, and chlorobenzene; various oxygenated organic compounds such as anisole, the dimethyl and diethyl ethers of ethylene glycol, of propylene glycol, and of diethylene glycol; normally-liquid saturated hydrocarbons including the open chain, cyclic, and alkyl-substituted cyclic saturated hydrocarbons such as pentane (e.g. isopentane), hexane, heptane, various normally-liquid petroleum hydrocarbon fractions, cyclohexane, the alkylcyclohexanes, and decahydronaphthalene.

Unreacted monomeric reagent oftentimes can be recovered from the reaction product by conventional techniques such as by heating said reaction product under reduced pressure. In one embodiment of the process of the present invention, the poly(ethylene oxide) (co)polymer product can be recovered from the reaction product by washing said reaction product with an inert, normally-liquid organic diluent, and subsequently drying same under reduced pressure at slightly elevated temperatures.

In another embodiment, the reaction product is dissolved in a first inert organic solvent, followed by the addition of a second inert organic solvent which is miscible with the first solvent, but which is a non-solvent for the poly(ethylene oxide) (co)polymer product, thus precipitating the (co)polymer product. Recovery of the precipitated (co)polymer can be effected by filtration, decantation, etc., followed by drying same as indicated previously. Poly(ethylene oxide) (co)polymers will have different particle size distributions depending on the processing conditions. The poly(ethylene oxide) (co)polymer can be recovered from the reaction product by filtration, decantation, etc., followed by drying said granular poly(ethylene oxide) (co)polymer under reduced pressure at slightly elevated temperatures, e.g., 30° C. to 40° C. If desired, the granular poly(ethylene oxide) (co)polymer, prior to the drying step, can be washed with an inert, normally-liquid organic diluent in which the granular polymer is insoluble, e.g., pentane, hexane, heptane, cyclohexane, and then dried as illustrated above.

Unlike the granular poly(ethylene oxide) (co)polymer which results from the suspension polymerization route as illustrated herein above, a bulk or solution copolymerization of ethylene oxide with one or more comonomer yields a non-granular resinous poly(ethylene oxide) (co)polymer which is substantially an entire polymeric mass or an agglomerated polymeric mass or it is dissolved in the inert, organic diluent. It is understood, of course, that the term “bulk polymerization” refers to polymerization in the absence of an inert, normally-liquid organic diluent, and the term “solution polymerization” refers to polymerization in the presence of an inert, normally-liquid organic diluent in which the monomer employed and the polymer produced are soluble.

The individual components of the polymerization reaction, i.e., the epoxide monomers, the catalyst, and the diluent, if used, may be added to the polymerization system in any practicable sequence as the order of introduction is not crucial for the present invention.

The use of the alkaline earth metal catalyst described herein above in the polymerization of epoxide monomers allows for the preparation of exceptionally high molecular weight polymers. Without being bound by theory it is believed that the unique capability of the alkaline earth metal catalyst to produce longer polymer chains than are otherwise obtained in the same polymerization system using the same raw materials with a non-alkaline earth metal catalyst is due to the combination of higher reactive site density (which is considered activity) and the ability to internally bind catalyst poisons.

Suitable poly(ethylene oxide) homopolymers and poly(ethylene oxide) copolymers useful in the method of the present invention have a weight average molecular weight equal to or greater than 100,000 daltons (Da) and equal to or less than 15,000,000 Da, preferably equal to or greater than 1,000,000 Da and equal to or less than 8,000,000 Da.

With the higher molecular weight polymers, viscosity measurements are challenging due to the difficulties encountered in dissolving the polymers in aqueous systems. During dissolution the mixture assumes a mucous-like consistency with a high tendency to gel. In some cases, extremely long chains are sensitive to shearing forces and must be stirred under very low shearing conditions in order to minimize mechanical degradation. The procedure for dissolving the polymers of the present invention may be found in Bulletin Form No. 326-00002-0303 AMS, published March 2003 by the Dow Chemical Company and entitled “POLYOX™ Water-Soluble Resins Dissolving Techniques”.

The term “1% aqueous solution viscosity” as used herein means the dynamic viscosity of a 1 weight % solution of the polymer in a mixture of water and isopropyl alcohol in a weight ratio of about 32:1. The weight percentage of polymer is based on the weight of water only, i.e., not including the isopropyl alcohol. When preparing the aqueous solutions of the polymers, the isopropyl alcohol is added first in order to allow the polymer particles to disperse before water is added. This minimizes gel formation and is critical to providing reliable viscosity measurements. The 1% aqueous solution viscosity of the ethylene oxide polymers according to the present invention is preferably greater than 1,200 mPa·s at 25° C. and less than 20,000 mPa·s at 25° C. The 1% aqueous solution viscosity of the ethylene oxide polymers is determined at 25° C. using a BROOKFIELD™ DV-II+digital viscometer. The BROOKFIELD guard leg is in place when making the measurement. RV spindle #2 and a speed of 2 RPM are employed to make the measurement. The spindle is immersed in the polymer solution, avoiding entrapping air bubbles, and attached to the viscometer shaft. The height is adjusted to allow the solution level to meet the notch on the spindle. The viscometer motor is activated, and the viscosity reading is taken 5 min after the viscometer motor is started.

Poly(ethylene oxide) (co)polymers are particularly suitable for use in the method of the present invention as flocculation agents for suspensions of particulate material, especially waste mineral slurries. Poly(ethylene oxide) (co)polymers are particularly suitable for the method of the present invention to treat tailings and other waste material resulting from mineral processing, in particular, processing of oil sands tailings.

Suitable amounts of the flocculant composition comprising the poly(ethylene oxide) (co)polymer to be added to the mineral suspensions range from 10 grams to 10,000 grams per ton of mineral solids. Generally the appropriate dose can vary according to the particular material and material solids content. Preferred doses are in the range 30 to 7,500 grams per ton, more preferably 100 to 3,000 grams per ton, while even more preferred doses are in the range of from 500 to 3,000 grams per ton. The flocculant composition comprising a poly(ethylene oxide) (co)polymer may be added to the suspension of particulate mineral material, e.g., the tailings slurry, in solid particulate form, an aqueous solution that has been prepared by dissolving the poly(ethylene oxide) (co)polymer into water, or an aqueous-based medium, or a suspended slurry in a solvent.

In the process of the present invention, the flocculant composition comprising a poly(ethylene oxide) (co)polymer may further comprise one or more other types of flocculant (e.g., polyacrylates, polymethacrylates, polyacrylamides, partially-hydrolyzed polyacrylamides, cationic derivatives of polyacrylamides, polydiallyldimethylammonium chloride (pDADMAC), copolymers of DADMAC, cellulosic materials, chitosan, sulfonated polystyrene, linear and branched polyethyleneimines, polyvinylamines, etc.) or other type of additive typical for flocculant compositions.

Coagulants, such as salts of calcium (e.g., gypsum, calcium oxide, and calcium hydroxide), aluminum (e.g., aluminum chloride, sodium aluminate, and aluminum sulfate), iron (e.g., ferric sulfate, ferrous sulfate, ferric chloride, and ferric chloride sulfate), magnesium carbonate, other multi-valent cations and pre-hydrolyzed inorganic coagulants, may also be used in conjunction with the poly(ethylene oxide) (co)polymer.

In one embodiment, the present invention relates to a process for dewatering oil sands tailings. As used herein, the term “tailings” means tailings derived from oil sands extraction operations and containing a fines fraction. The term is meant to include fluid fine tailings (FFT) and/or mature fine tailings (MFT) tailings from ongoing extraction operations (for example, thickener underflow or froth treatment tailings) which may bypass a tailings pond and from tailings ponds. The oil sands tailings will generally have a solids content of 10 to 70 weight percent, or more generally from 25 to 40 weight percent, and may be diluted to 20 to 25 weight percent with water for use in the present process.

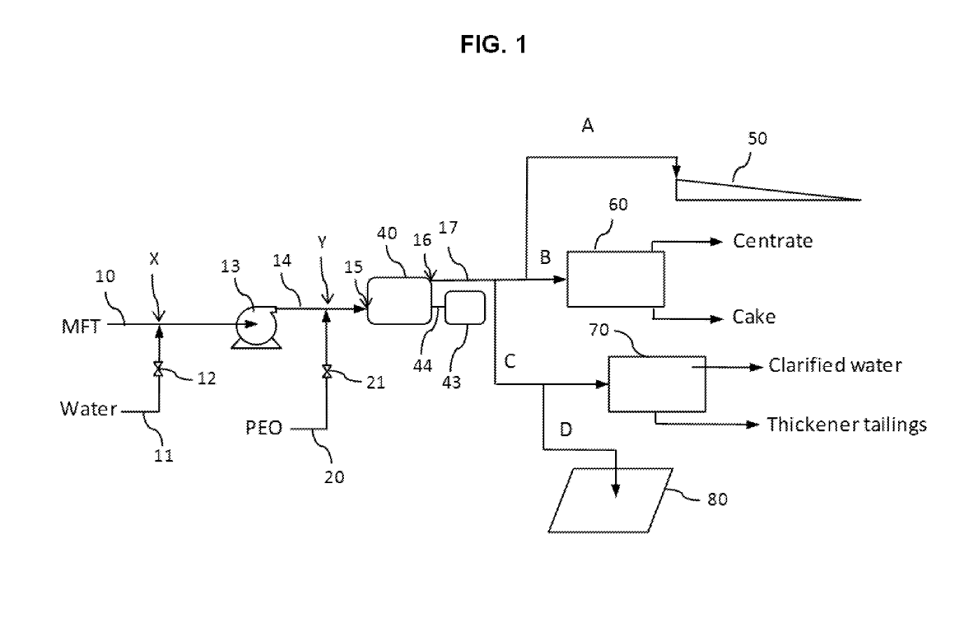

A schematic of four embodiments, A, B, C and D, of the present invention is shown in FIG. 1. The aqueous suspension containing solids such as oil sands mature fine tailings (MFT) in line 10 are pumped via pump 13 through a transportation conduit, preferably a first pipeline, line 14. If desired, additional water can be added to the MFT through line 11 at Point X. The flocculant composition comprising a poly(ethylene oxide) (co)polymer (referred herein after to as “PEO”) is added through line 20 at Point Y to the aqueous MFT suspension and the MFT and PEO are mixed in-line to form a dough-like mixture. To facilitate blending and interactions between the MFT and the PEO the combined stream can flow through a pipeline optionally containing a static mixing device, such as an in-line static mixer, or the like (not shown in the drawings) may be located in the first pipeline 14 after the addition point of the PEO Y and before the in-line pipeline reactor 40.

The dough-like mixture initially has a viscosity equal to or greater than double the viscosity of the initial mixture of MFT and PEO, preferably equal to or greater than three times the viscosity of the initial mixture of the MFT and PEO. Typically, the dough-like material has a viscosity equal to or greater than 4,000 cP, preferably equal to or greater than 6,000 cP, more preferably equal to or greater than 8,000 cP, more preferably equal to or greater than 10,000 cP. Viscosity is conveniently determined using a Brookfield DV3T viscometer with a V73 spindle.

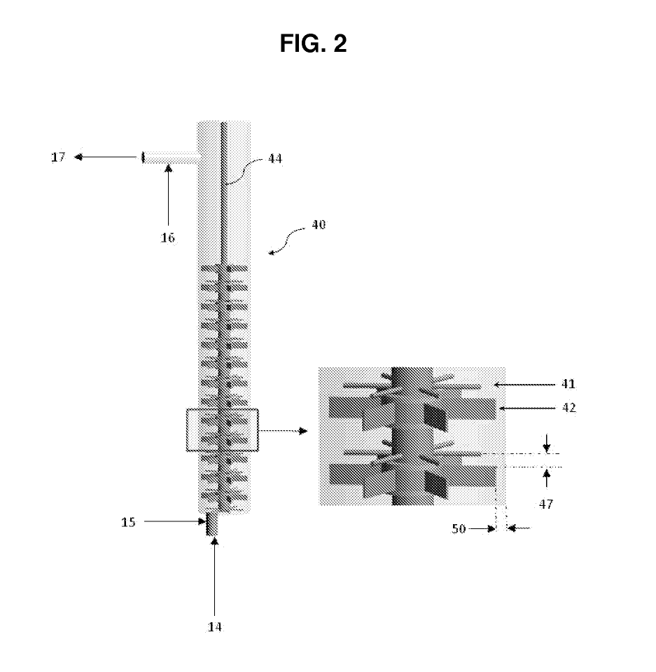

Generally, the flocculant composition comprising a poly (ethylene oxide) (co)polymer inlet and the MFT inlet are separated spatially. The dough-like mixture enters an in-line pipeline reactor 40. The pipeline reactor 40 comprises one or more rotor 41, preferably in combination with one or more stator 42, FIG. 2. Preferably, one or more rotor 41 and one or more stator 42 are arranged in an alternating fashion, i.e., rotor, stator, rotor, stator, etc. It is understood that the size, location and number of rotors and/or stators used in the in-line dynamic mixer 40 is dependent upon the overall dimensions (volume) of the dynamic mixer necessary for a particular operation.

The improvement in the process of the present invention involves the location and conditions under which the PEO is added to, and mixed with, the suspension containing solids, FIG. 1. The process of the present invention is conducted in a pipeline reactor 40 located within the pipeline comprising a first pipe 14 in which material enters the pipeline reactor 40 and a second pipe 17 in which material exits the pipeline reactor 40. Once material has exited the pipe line reactor 40 it may be further conditioned, treated and/or deposited in a deposition area. Generally, the line 14 which enters the pipeline reactor 40 is the same (i.e., the same diameter) as the line 17 which leaves the pipeline reactor 40, however the line 14 which enters the pipeline reactor 40 may have a larger diameter than line 17 which leaves the in-line reactor 40, or the line 14 which enters the pipeline reactor 40 may have a smaller diameter than line 17 which leaves the in-line reactor 40. Typical industrial tailings pipeline 14 diameters are in the range from 8 inches to 36 inches.

The special orientation, with regard to the ground, of the pipeline reactor 40 in the process of the present invention is not limited, it may be horizontal, vertical, or at any angle in between. Preferably the pipeline reactor 40 is in a vertical orientation wherein the dough-like mixture of MFT and PEO enters directly through line 14 at the bottom of the pipeline reactor 40 or optionally through the reactor inlet pipe 15 and then flows out the top of the pipeline reactor 40 directly into line 17 or optionally through the reactor outlet pipe 16 into line 17. The internal diameter of pipe 14 may be the same, larger, or smaller than the internal diameter of the reactor inlet pipe 15. The internal diameter of pipe 17 may be the same, larger, or smaller than the internal diameter of the reactor outlet pipe 16.

The reactor inlet pipe 15 and reactor outlet pipe 16 independently have an internal diameter. Preferably the internal diameter of the reactor inlet pipe 15 is equal to or less than the internal diameter of the in-line reactor 40. Preferably the internal diameter of the reactor outlet pipe 16 is equal to or less than the internal diameter of the in-line reactor 40. The internal diameter of the reactor inlet pipe 15 may be equal to or different from the internal diameter of the reactor outlet pipe 16. In one embodiment, the internal diameter of the reactor inlet pipe 15 is equal to the internal diameter of the reactor outlet pipe 16. In another embodiment, the internal diameter of the reactor inlet pipe 15 may be greater than the internal diameter of the reactor outlet pipe 16. In another embodiment, the internal diameter of the reactor inlet pipe 15 may be less than the internal diameter of the reactor outlet pipe 16. The ratio of inlet reactor pipe 15 internal diameter to in-line reactor 40 internal diameter is 1:1, preferably 1:2, more preferably 1:3, more preferably 1:4, more preferably 1:5. The ratio of outlet reactor pipe 16 internal diameter to in-line reactor 40 internal diameter is 1:1, preferably 1:2, more preferably 1:3, more preferably 1:4, more preferably 1:5.

The ratio of pipe 14 internal diameter to in-line reactor 40 internal diameter is 1:1, preferably 1:2, more preferably 1:3, more preferably 1:4, and more preferably 1:5.

Preferably, the internal diameter of the pipeline reactor 40 is at least equal to or greater than the internal diameter of the pipe 14 which enters the in-line reactor 40 and equal to or less than 10 times the internal diameter of the pipe 14, preferably equal to or less than 6 times the internal diameter of the pipe 14, preferably equal to or less than 5 times the internal diameter of the pipe 14, preferably equal to or less than 4 times the internal diameter of the pipe 14, preferably equal to or less than 3 times the internal diameter of the pipe 14, and preferably equal to or less than 2 times the internal diameter of the pipe 14.

The pipeline reactor 40 of the present invention is not a separate tank, a stirred tank reactor, a separation vessel, a batch vessel, a semi-batch vessel, or the like. The pipeline reactor 40 may have various components and configurations, some of which will be described herein below, FIG. 2 to FIG. 4.

The addition stage for the introduction of the PEO into the aqueous solution of oil sands tailings comprises any suitable means for adding the PEO, for example an injector quill, a single or multi-tee injector, an impinging jet mixer, a sparger, a multi-port injector, and the like. The flocculant composition comprising a poly(ethylene oxide) (co)polymer is added as a solid, slurry, or dispersion, preferably an aqueous solution. The addition stage is herein after referred to as in-line addition. The in-line addition of the PEO occurs through line 20 at point Y under conditions which exclude dynamic mixing, in other words, the addition occurs without mechanical energy input (i.e., moving parts) at the point of initial contacting of the two feeds. The PEO injection point can be before or within a static mixer or into the pipeline. In one embodiment, the mixing is facilitated by the presence of an in-line static mixer (not shown in the FIGs.) downstream from the injector in the direction of flow from where the PEO is added.

After the flocculant composition comprising a poly(ethylene oxide) (co)polymer is added and begins to mix with the oil sands tailing suspension a viscous, but zero to low yield stress, dough-like mixture is formed. Typically, the dough-like mixture forms within 20 seconds, preferably 15 seconds, more preferably 12 seconds, more preferably 10 seconds, more preferably 5 seconds, more preferably 2 seconds, most preferably within 1 second. As defined herein, low yield stress means less than 65 Pa, preferably less than 50 Pa.

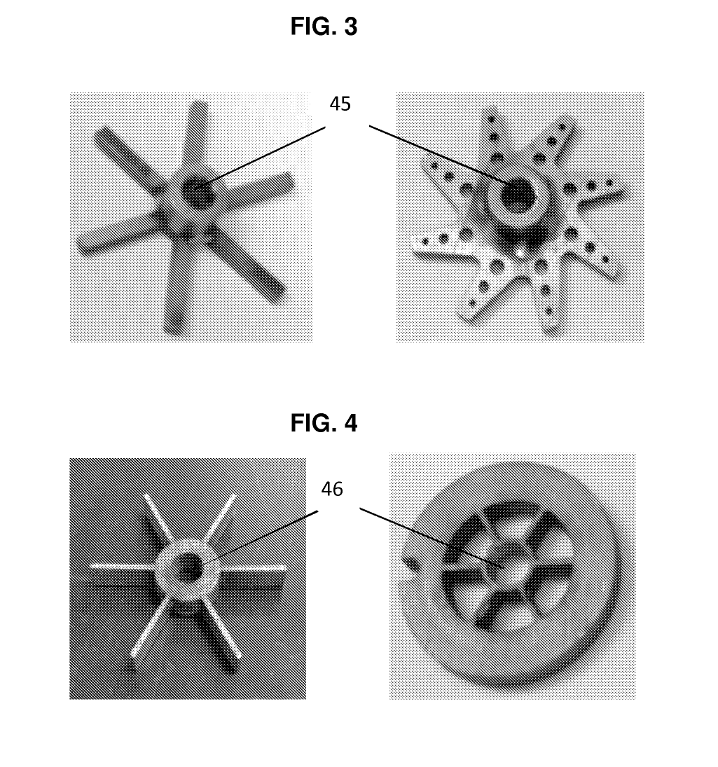

The pipeline reactor 40 having an inside surface and an outside surface comprises one or more rotor 41. A rotor is a rotating impeller designed to impart shearing forces to the fluid. A rotor 41 may consist of simple round pins protruding from a hub 45 (FIG. 3) left side, knife-edge type blades, square pins, or combinations thereof (FIG. 3) right side, or any of a variety of other blade designs suitable for imparting dynamic mixing. One or more different rotor types may be used within different stages of a single in-line dynamic mixer. The first rotor is optimally placed just after the feed entry point into the in-line reactor 40 to provide immediate shear forces as the dough-like mixture enters.

In one embodiment, a stator 42 is placed after a rotor 41, preferably between two rotors 41. A suitable design is as a stationary spoked “hub” of a given depth and is designed to prevent solid body rotation within the pipeline reactor 40. The stator 42 may be held in place by any suitable means, such as a wall baffle, an anchor line, or a weld. The mixer shaft 44 passes through the stator hub 46 but the stator 42 is not attached to the mixer shaft 44. A stator 42 may consist of simple round pins protruding from a hub (FIG. 2), knife-edge type blades, square pins, or combinations thereof, or any of a variety of other blade design. Further, stator spokes or pins may extend from the hub 46 to the inside wall of the in-line reactor 40 or may be blocked off at the outer radius (FIG. 4). One or more different stator 42 types may be used within different stages of a single in-line dynamic mixer 40.

The in-line reactor 40 of the present invention may have from 1 to 100 rotors 41, preferably from 1 to 75 rotors 41, more preferably from 1 to 50 rotors 41, more preferably from 1 to 40 rotors 41, more preferably from 1 to 30 rotors 41, more preferably from 1 to 25 rotors 41, more preferably from 1 to 20 rotors 41, more preferably from 1 to 15 rotors 41, more preferably from 1 to 10 rotors 41, and more preferably from 1 to 5 rotors 41. Independently from the number of rotors, the in-line reactor 40 of the present invention may have from 1 to 100 stators 42, preferably from 1 to 75 stators 42, more preferably from 1 to 50 stators 42, more preferably from 1 to 40 stators 42, more preferably from 1 to 30 stators 42, more preferably from 1 to 25 stators 42, more preferably from 1 to 20 stators 42, more preferably from 1 to 15 stators 42, more preferably from 1 to 10 stators 42, and more preferably from 1 to 5 stators 42.

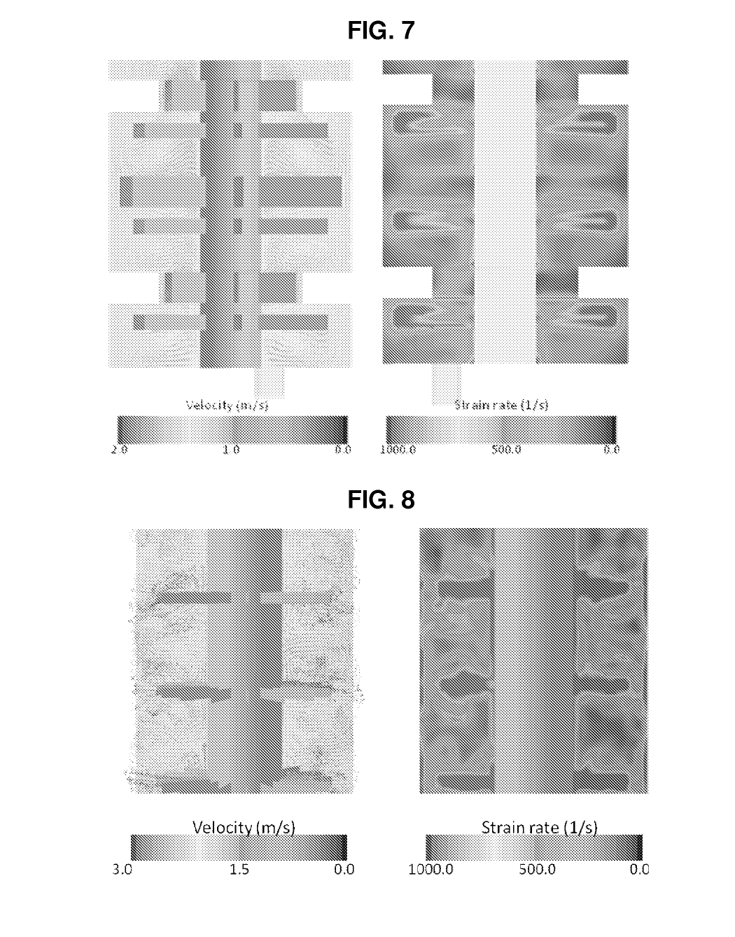

A single rotor 41 optionally in combination with a stator 42 is referred to as a “stage”. A stage provides a nominal shear zone between the rotor 41 and stator 42 that imparts a cutting action to the fluid. Additionally the rotor also provides a chopping/cutting action to the dough consisting of MFT and polymer (FIG. 7 and FIG. 8) by generating localized high shear zones near the tip of the rotors. One additional function of the stators is to suppress the tangential velocity of the fluid to improve the effectiveness of the rotors. The pipeline reactor of the process of the present invention comprises at least one stage, preferably a minimum of two or more stages, preferably from 1 to 5 stages, preferably from 1 to 10 stages, preferably from 1 to 15 stages, preferably from 1 to 20 stages 1 to 25 stages, preferably from 1 to 30 stages, preferably from 1 to 40 stages, preferably from 1 to 50 stages, preferably from 1 to 75 stages, preferably from 1 to 100 stages, the number of stages is not limited and as many may be used for a particular operation.

In one embodiment of the present invention, the in-line reactor 40 has one or more rotor 41 and one or more stator 42. Preferably, there is close clearance between a rotor 41 and a stator 42 in order to provide maximum nominal shear for a given rotational rate. A nominal shear can be defined by the rotor tip speed (π·impeller diameter·impeller rotations per second) divided by the gap 47 between the rotor and the stator. Preferably, the minimum nominal shear rate is equal to or greater than 1000 s⁻¹. The tip speed divided by the gap distance 47 between stator and rotor is used to calculate the nominal shear. A suitable gap width 47 may be determined based on the internal diameter of the pipe using the ratio of the gap width:pipe internal diameter wherein the ratio is equal to or greater than 1:200 and equal to or less than 1:8. For example, for a pipe having an internal diameter of 200 mm, the gap may be 1 mm, 2 mm, 3 mm, 4 mm, 5 mm, up to 25 mm. The gap 47 between each rotor/stator may be the same or independently different.

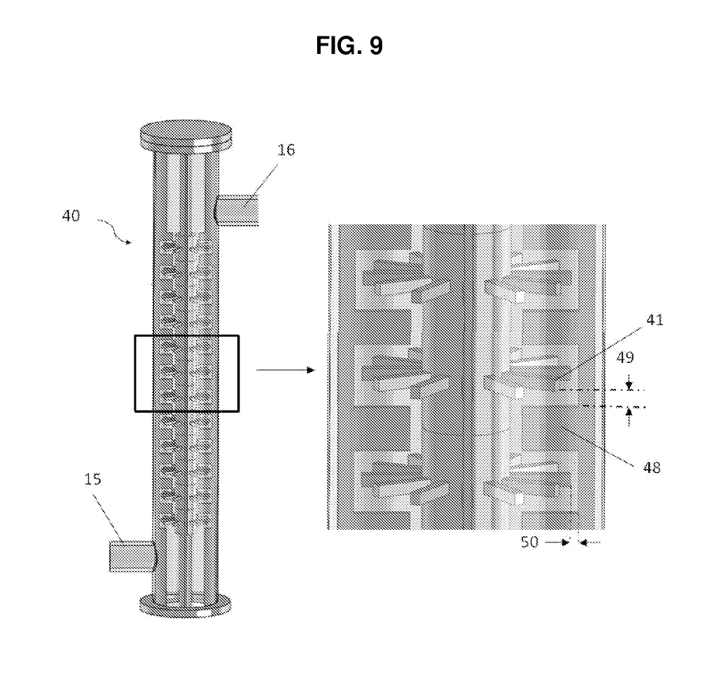

In another embodiment of the present invention, the in-line reactor has one or more rotors 41 and one or more baffle 48 placed along the dynamic mixer wall to disrupt the predominantly tangential flow in the dynamic mixer and thus enhances mixing and average shear in the mixer, FIG. 9. Preferably, there is close clearance between a rotor 41 and the baffle 48 in order to provide maximum nominal shear for a given rotational rate. Preferably, the minimum nominal shear rate is equal to or greater than 1000 s⁻¹. The tip speed divided by the gap 49 distance between rotor 41 and baffle 48 is used to calculate the nominal shear. A suitable gap width 49 may be determined based on the internal diameter of the pipe using the ratio of the gap width:pipe internal diameter wherein the ratio is equal to or greater than 1:200 and equal to or less than 1:8. The gap 49 between each rotor/baffle may be the same or independently different.

It is preferable that the gap 50 between the rotor tip and the in-line dynamic mixer inside wall and/or baffle remains small. A suitable gap width 50 may be determined based on the internal diameter of the pipe using the ratio of the gap width:pipe internal diameter wherein the ratio is equal to or greater than 1:200 and equal to or less than 1:8.

It is preferable that no significant bypassing occurs in the pipeline reactor, i.e., all fluid elements entering the mixer chamber have a significant probability of entering a high-shear environment. A stator 42 can be installed to be partially blocked off at the outer radius in order to force the fluid towards the center of the mixing chamber, thereby preventing bypassing of some fluid at the walls, FIG. 4 (right side).

The rotors 41 are connected to a mixer shaft 44 which is rotated by a drive 43 to provide shear to the dough-like mixture of MFT and PEO having zero to low yield stress. In one embodiment, said drive is provided at the opposite end from where the dough-like mixture enters the in-line reactor, may be, for example a variable speed motor or constant speed motor. The shear breaks up the dough-like mixture into microflocs of MFT, thereby allowing the water to flow more readily. However, overshearing may cause the flocs to be irreversibly broken down, resulting in resuspension of the fines in the water thereby preventing water release and drying. The resulting microfloc solution has a viscosity equal to or lower than 1,000 cP and a yield stress equal to or lower than 300 Pa, preferably equal to or less than 40 Pa, more preferably equal to or lower than 30 Pa. Yield stress is conveniently determined with a Brookfield DV3T rheometer.

Not to be held to any particular theory, we believe the nature of the microfloc of the present process reduces the amount of water trapped versus large floc structures as with conventional flocculants, thus the water is more easily released from the solids as they settle and consolidate. Moreover, the process of the present invention produces a continual dewatering system in contrast to the conventional MFT flocculation processes where the water is principally released in the initial few hours after the deposition process. The process of the present invention also avoids multiple conditioning steps taught in conventional flocculation processes. Furthermore, the microfloc is significantly more tolerant of high shear conditions and can be transported and handled with reduced floc breakage/fines generation which reduce dewatering performance. Dewatering is typically determined using gravity settling in graduated cylinders, capillary suction time (CST) measurement, centrifugation followed by measuring the resultant height of solids or a large strain consolidometer. Gravity settling can be performed in a large graduated cylinder where the mud height is captured as a function of time using digital image collection and analysis. The mud height can then be used to calculate percent solids from the initial slurry solid content. Unless otherwise noted, dewatering reported herein is determined by gravity settling in a graduated cylinder.

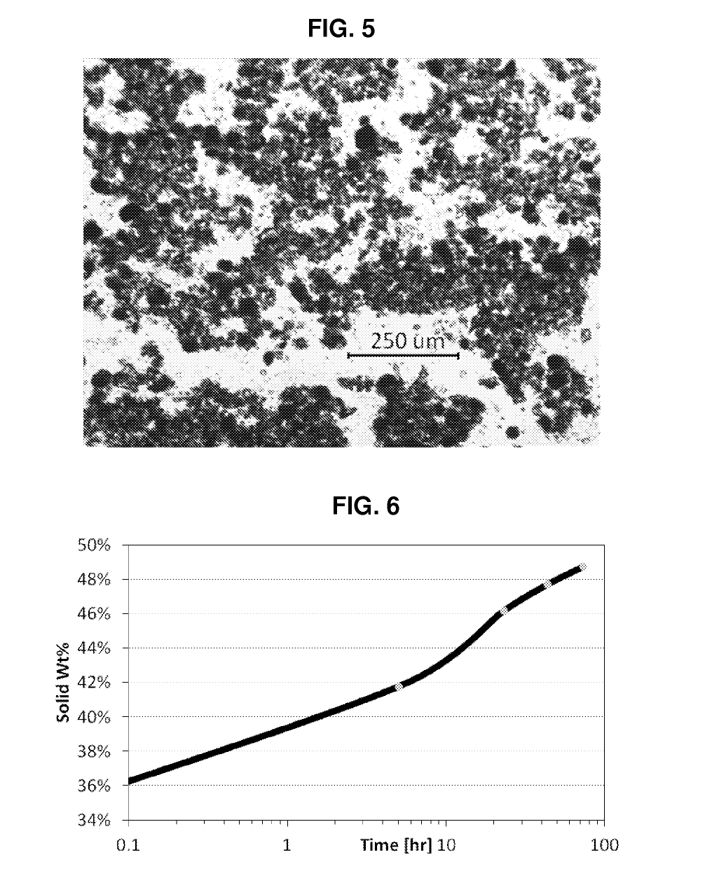

Preferably, the microflocs which result from the dynamic mixing in the process of the present invention have an average size between 10 to 50 microns, FIG. 5. Preferably, the average microfloc size is equal to or greater than 1 micron, more preferably equal to or greater than 5 microns, more preferably equal to or greater than 10 microns, more preferably equal to or greater than 15 microns, even more preferably equal to or greater than 25 microns. Preferably, the average microfloc size is equal to or less than 1000 microns, more preferably equal to or less than 500 microns, more preferably equal to or less than 250 microns, more preferably equal to or less than 100 microns, even more preferably equal to or less than 75 microns. A convenient way to measure microfloc size is from microscopic photos.

Preferably, in the process of the present invention, there is a concentration of solids to at least 45 weight percent after 20 hours from a starting MFT solution of from 30 to 40 weight percent solids. Preferably there is continued thickening with an increase of solids equal to or greater than 50 weight percent over a timeframe of 100 to 10,000 hours.

Preferably, the process of the present invention provides a floc having a settling rate for 100 hours or more equal to or greater than 4 weight percent per log10 hour, preferably equal to or greater than 4.5, preferably equal to or greater than 5, and more preferably equal to or greater than 5.5 weight percent per log10 hour. Settling rate is defined as the change in solids weight percent of the solids below the mudline over time.

In one embodiment of the process of the present invention (A) shown in FIG. 1, the flocculated MFT is transported to a thin lift sloped deposition site 50 having a slope of 0.5 percent to 4 percent to allow water drainage. This water drainage allows the material to dry at a more rapid rate and reach trafficability levels sooner. Additional layers can be added and allowed to drain accordingly.

In another embodiment of the process of the present invention (B) shown in FIG. 1, the flocculated MFT is transferred via line 17 to a centrifuge 60. A centrifuge cake solid containing the majority of the fines and a relatively clear centrate having low solids concentrations are formed in the centrifuge 60. The centrifuge cake can then be transported, for example, by truck, pipeline, or conveyor belt and deposited in a drying cell.

In a further embodiment of the process of the present invention (C) shown in FIG. 1, the flocculated MFT is removed and placed in a thickener 70, said thickener 70 may comprise rakes (not shown in FIG. 1), to produce clarified water and thickened tailings for further disposal.

Yet a further embodiment of the process of the present invention (D) is shown in FIG. 1, the flocculated MFT is deposited at a controlled rate into an accelerated dewatering cell 80, for example a tailings pit, basin, dam, casing, culvert, or pond, or the like which acts as a fluid containment structure. The containment structure may be filled with flocculated MFT continuously or the treated MFT can be deposited in layers of varying thickness. The water released may be removed using pumps (not shown in FIG. 1). The deposit fill rate is such that maximum water is released during or just after deposition. Preferably, the deposited particulate mineral material will reach a substantially dry state. In addition the particulate mineral material will typically be suitably consolidated and firm e.g., due to simultaneous settling and dewatering to enable the land to bear significant weight.

### EXAMPLES

### Example 1

To a 32 weight percent solids MFT, obtained from a tailings pond in northern Alberta, Canada, pumped through a 1 inch pipe is added 0.4 weight percent aqueous solution of a poly (ethylene oxide) homopolymer having a weight average molecular weight of 8,000,000 Da and a viscosity of at least 10,000 cP available as POLYOX™ WSR 308 poly(ethylene oxide) polymer from The Dow Chemical Company. The combined flow is pumped through the system at a rate of 1.75 gallons per minute (gpm). After the PEO (dosed at 1,900 g/ton of dry solids) and MFT streams are combined a dough-like mixture is formed having a viscosity of greater than 10,000 cP. The dough-like mixture is introduced into a 2 stage in-line reactor to provide dynamic mixing. This in-line reactor has an internal diameter of 2 inches and comprises two rotating 6 pin rotors and 3 flat blade stators, arranged in an alternating configuration: stator, rotor, stator, rotor, and stator. The rotors are rotated at a speed of 1500 rotations per minute (rpm). The dough-like mixture is broken up to form flocculated oil sands tailings made up of microflocs having sizes generally from 1 micron to 500 microns. The flocculated oil sands tailings exit the in-line reactor and enters a series of eleven KOMAX™ static mixers. Each static mixer unit has 12 mixer elements and has an internal diameter of 0.75 inch. The mixture exits the static mixer series and flows directly into a graduated cylinder and is allowed to settle. The solids level, in milliliters (ml) is recorded versus time in minutes (min).

Table 1 provides the settling data for the resulting mixture. Although the majority of the dewatering occurs in the first 3 hours, additional dewatering continues past 40 hours.

TABLE 1

| TIME | Mud Height | |
|---|---|---|
| [min] | [ml] | Solid Wt % |
| 0 | 1545 | 26.7 |
| 141 | 920 | 40.6 |
| 201 | 905 | 41.2 |
| 1111 | 860 | 42.8 |
| 1461 | 850 | 43.2 |
| 2556 | 840 | 43.6 |

### Example 2

To a 36 weight percent solids MFT obtained from a tailing pond in northern Alberta, Canada, pumped through a 1 inch pipe is added 0.4 weight percent aqueous solution of poly (ethylene oxide) homopolymer having a weight average molecular weight of 8,000,000 Da and 1% viscosity of at least 10,000 cP available as POLYOX WSR 308 poly(ethylene oxide) polymer from The Dow Chemical Company. The mixture is pumped through the system at a flow rate of 1.85 gpm. After the PEO and MFT streams are combined a dough-like mixture is formed having a viscosity of greater than 10,000 cP. The dough-like mixture is introduced into a 13 stage (each stage comprising alternating rotors/stators) in-line reactor to provide dynamic mixing having an internal diameter of 2 inches. The inlet and outlet piping to the dynamic mixer are both 0.824 inches. The 13 rotor in the in-line reactor are 6 pin impellers which rotate at a speed of 1700 rpm. The dough-like mixture is broken up to form a flocculated oil sands tailings made up of microflocs having sizes generally from 1 microns to 500 microns. The flocculated oil sands tailings exits the in-line reactor and enters a 12 element 3 inch diameter SMX static mixer. The fluid mixture exits the 3 inch static mixer and is pumped through 30 feet of 0.75 inch flexible hosing into a 30 gallon tank. The settling curve for the resulting mixture is determined by visually observing the settling of the solid-water interface commonly called the mudline and is shown in FIG. 6.

### Example 3

A single phase, non-newtonian fluid, laminar, Computational Fluid Dynamic (CFD) simulation is performed using the geometry of the dynamic mixer to understand the flow pattern inside the dynamic mixer and thus predict the critical design parameters. The viscosity μ was assumed to follow the power law model given by

μ=K\dot{γ}ⁿ⁻¹

where K is the flow consistency index and n is the flow behavior index and \dot{γ} is the shear rate. The values of parameters K and n are set to be 1.973 and 0.3 respectively which closely represent the behavior of the MFT and polymer mixer passing through the in-line dynamic mixer. A flow rate of 2 GPM is chosen for the simulation. Note that the geometry of the in-line dynamic mixer is the same as the one described in the herein above example with an internal diameter of 2 inches and a 6 pin impeller rotating at 1800 RPM forms the rotor. FIG. 7 shows vector plot (left) and a contour plot of shear rate (right) inside the in-line dynamic mixer. FIG. 7 (right) shows the high shear zone in the in-line dynamic mixer occurs at the tip of the rotors starting at ˜3000 sec⁻¹ right beside the tip and quickly reducing to 1000 sec⁻¹ 1 mm away from the tip of the rotor.

### Example 4

A single phase, non-newtonian fluid, laminar, CFD simulation is performed using the geometry of the dynamic mixer to understand the flow pattern inside the dynamic mixer and thus predict the critical design parameters. The viscosity μ is assumed to follow the power law model given by

μ=K\dot{γ}ⁿ⁻¹

where K is the flow consistency index and n is the flow behavior index and \dot{γ} is the shear rate. The values of parameters K and n are set to be 1.973 and 0.3 respectively which closely represents the behavior of the MFT and polymer mixer passing through the in-line dynamic mixer.

The geometry of the dynamic mixer used for this CFD simulation is different from the geometry used in Example 3. FIG. 9 shows the geometry of the dynamic mixer which is characterized by the presence of baffles 48. The dynamic mixer vessel is 8 inches in diameter and 34 inches in length. There are 4 baffles placed 90° apart, each of the baffle has a thickness of 0.25 inches. 16 pin impellers are used in this simulation with each of the pins made up of 0.325 inch by 0.375 inch rectangular cross-section piece. A total of 12 impellers are used with a spacing of 2 inches between them. The agitation speed is chosen to be 900 RPM.

FIG. 8 shows the plots of velocity vectors (left) and shear rate profile (right) obtained from the CFD simulations. The baffles can disrupt the tangential flow and thus provide better mixing and higher shear rates as shown in FIG. 8.

What is claimed is:

1. An in-line apparatus for dynamically mixing a dough-like mixture of a polymeric flocculant and an aqueous suspension of oil sands fine tailings,
wherein one or more rotor (41) connected to a mixer shaft (44) is rotated by a drive (43), which is arranged in an in-line reactor (40) through which the dough-like mixture flows into through a first pipe (14) and out of through a second pipe (17),
wherein one or more stationary stator (42) having a stator hub (46) through which the mixer shaft (44) passes and is not attached is arranged in an alternating fashion with the one or more rotor (41).

2. An apparatus according to claim 1 wherein the in-line reactor (40) has an internal diameter, the first pipe (14) has an internal diameter, and the internal diameter of the in-line reactor (40) is equal to or less than five times the internal diameter of the first pipe (14).

3. An apparatus according to claim 1 characterized in that there are from 1 to 100 rotors (41) and, independent from the number of rotors (41), from 1 to 100 stators (42).

4. An apparatus according to claim 1 characterized in that the one or more rotor (41) consist of round pins, knife-edge type blades, square pins, or combination thereof, protruding from a hub (45).

5. An apparatus according to claim 1 characterized in that one or more stator (42) consist of round pins, knife-edge type blades, square pins, or combination thereof, protruding from a hub (46).

6. An apparatus according to claim 1 characterized in that each rotor (41) is separated from each stator (42) by a gap (47) wherein the gap (47) is a distance of from 1 mm to 25 mm.

7. An apparatus according to claim 1 characterized in that there is a gap (47) between the tip of the rotor (41) and the inside surface of the in-line reactor (40) wherein the width of the gap (47) is determined using the ratio of the gap width:pipe internal diameter wherein the ratio is equal to or greater than 1:200 and equal to or less than 1:8.

8. An apparatus according to claim 1 characterized in that there can be one or more wall baffle (48) along the inside surface of the in-line reactor (40) wherein the width of the gap (49) between the tip of the rotor (41) and the baffle (48) is determined using the ratio of the gap width:pipe internal diameter wherein the ratio is equal to or greater than 1:200 and equal to or less than 1:8.

9. An apparatus according to claim 1 wherein the polymeric flocculant is a poly(ethylene oxide) homopolymer or a poly(ethylene oxide) copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

10. An apparatus according to claim 9 wherein the poly(ethylene oxide) (co)polymer has a molecular weight of equal to or greater than 1,000,000 Da.
